(19) United States
(12) Patent Application Publication
(10) Pub. No.: US 2024/0348089 A1
(43) Pub. Date: Oct. 17, 2024

(54) WEIGHT-LIFT AND DROP ENERGY STORAGE SYSTEM

(71) Applicants: Glenn Lehle, Cypress, TX (US); Michael S. Bahorich, Houston, TX (US)

(72) Inventors: Glenn Lehle, Cypress, TX (US); Michael S. Bahorich, Houston, TX (US)

(21) Appl. No.: 18/636,925

(22) Filed: Apr. 16, 2024

Related U.S. Application Data
(60) Provisional application No. 63/496,587, filed on Apr. 17, 2023.

(51) Int. Cl. H02J 15/00; F03G 3/00

(52) U.S. Cl. CPC H02J 15/007; F03G 3/094

(57) ABSTRACT

An apparatus for storing energy includes a subsurface well. A cable is cooperatively engaged with a winch. The winch has a motor/generator wherein electrical power applied to the motor/generator operates the winch to retract the cable, and wherein motion applied to the cable operates the winch to generate electrical power. A plurality of weights is disposed proximate the well. The plurality of weights is shaped to enable movement along an interior of the subsurface well. Means for selectively connecting each of the weights to the cable is provided, wherein each of the plurality of weights is individually connectable to the cable to either (i) induce motion on the cable by gravity or (ii) be withdrawn from the well by the cable.

### CROSS REFERENCE TO RELATED APPLICATIONS

Benefit is claimed from U.S. Provisional Application No. 63/496,587 filed on Apr. 17, 2023 and incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of energy storage used in connection with intermittent electric power generators. More particularly, the disclosure relates to energy storage using weights deployed on a winched cable dropped in wells to release stored energy, and wherein the weights are lifted from the wells to store energy when the intermittent power generators are producing electric power.

Electric power production using in particular non-dispatchable (intermittent) generators, e.g., solar and wind, requires storage to release electric energy when the intermittent source output is below an applied electrical load, and to store excess energy when the intermittent source output is above the applied electrical load. Various forms of energy storage include, for example, electrochemical batteries, pumped liquid storage and gravity, such as weight lift/drop.

An example system using weight lift/drop is described in U.S. Pat. No. 7,973,420 issued to Scott. The system disclosed in the '420 patent includes facilities to dispose large masses (weights) that are electro/mechanically raised from their lowest levels to maximum heights against the force of gravity and locked in place to store potential energy. Electrically responsive motors are used to produce work on the large masses to move them from a position of low potential energy (low elevation) to a position of higher potential energy (higher elevation). Later, when electrical energy is desired to be obtained from the storage facility, the weights are controllably dropped to lower levels by gravity. During the weight drops, the weights are connected to drive electrical generators and electrical energy is produced.

U.S. Pat. No. 10,830,216 issued to Pedretti et al. discloses a weight lift/drop energy storage system including a crane and a plurality of blocks, where the crane is operable to move blocks from a lower elevation to a higher elevation (via stacking of the blocks) to store electrical energy as potential energy of the blocks, and then operable to move blocks from a higher elevation to a lower elevation (via unstacking of the blocks) to generate electricity based on the kinetic energy of the block when lowered (e.g., by gravity).

There continues to be a need for improved, lower cost apparatus and methods to store energy, e.g., from intermittent electrical generators by using gravity.

### SUMMARY

One aspect of the present disclosure is an apparatus for storing energy. An apparatus according to this aspect of the disclosure includes a subsurface well. A cable is cooperatively engaged with a winch. The winch has a motor/generator wherein electrical power applied to the motor/generator operates the winch to retract the cable, and wherein motion applied to the cable operates the winch to generate electrical power. A plurality of weights is disposed proximate the well. The plurality of weights is shaped to enable movement along an interior of the subsurface well. Means for selectively connecting each of the weights to the cable is provided, wherein each of the plurality of weights is individually connectable to the cable to either induce motion on the cable by gravity by allowing movement of the weights into the well or be withdrawn from the well by the cable.

In some embodiments, the means for selectively connecting comprises a conveyor disposed proximate the winch, and the winch comprises a spooling arm movable between a position above the conveyor, wherein a proximate one of the plurality of weights is disposed, and a position above the well.

In some embodiments, the conveyor comprises a belt conveyor wherein the weights are stored outside the well.

In some embodiments, the conveyor comprises a rotary table conveyor wherein the weights are stored outside the well.

In some embodiments, the means for selectively connecting comprises a releasable latch, wherein the weights are stored within the well.

Some embodiments further comprise a controller in communication with the winch and with a sensor. The sensor is operable to detect an excess load condition wherein a load applied to an intermittent electrical generator exceeds a power output of the intermittent electrical generator. The sensor is also operable to detect an excess power condition wherein the power output exceeds the load. The controller is operable to cause the winch to operate to release one of the plurality of weights into the well during the excess load condition and to lift one of the plurality of weights to the top portion of the well during excess power condition.

In some embodiments, the means for selectably releasing comprises a weight latch disposed proximate a top of the well and a cable latch disposed at an end of the cable, wherein a first one of the plurality of weights is latchable in the weight latch. The first one of the plurality of weights comprises a through bore, and the cable latch is operable to connect to a latch feature on an upper end of a second one of the plurality of weights disposed below the first one of the plurality of weights.

A method for releasing stored energy according to another aspect of the present disclosure includes disposing a first weight in a weight latch proximate a top of a well. A cable having a cable latch at one end is passed through a bore in the first weight. The cable latch is attached to a top end of a second weight disposed in the well below the first weight. A load on an intermittent electric generator is detected. When the load exceeds a power output of the generator, operating A motor/generator winch in contact with the cable is operated to release the second weight into the well. When the second weight reaches the bottom of the well. The cable is retracted until it contacts a bottom of the first weight. The weight latch is released, allowing the first weight to move toward the bottom of the well.

A method for storing energy according to another aspect of the disclosure includes detecting a load on an intermittent electric generator. When the load is less than a power output of the generator, a winch is operated to lift a first weight stacked above a second weight at a bottom of a well, until the first weight is disposed in a weight latch proximate the top of the well. The weight latch is operated to retain the first weight. The cable is extended into the well until a cable latch on an end of the cable contacts and engages a latching feature on a top of the second weight. The second weight is lifted from the bottom of the well by operating the winch to withdraw the cable from the well.

An apparatus for storing energy according to another aspect of the present disclosure includes a plurality of subsurface wells. Disposed proximate to each of the plurality of wells is a cable cooperatively engaged with a winch. The winch has a motor/generator wherein electrical power applied to the motor/generator operates the winch to retract the cable, and wherein motion applied to the cable operates the winch to generate electrical power. A plurality of weights is disposed proximate the subsurface well, and the plurality of weights is shaped to enable movement along an interior of the subsurface well. Means for selectively connecting each of the weights to the cable provides that each of the plurality of weights is individually connectable to the cable to either induce motion on the cable by gravity by lowering the weights into the subsurface well or raising up the well by the cable. A sensor is arranged to detect existence of and magnitude of an excess load condition or an excess power condition on a power line. A multi well controller is in signal communication with the sensor and in communication with the motor/generator on each winch. The multi well controller is operable to cause a number of the motor/generators to operate, respectively, as a motor or a generator in proportion to the magnitude of the excess load condition or the excess power condition.

In some embodiments, the means for selectively connecting comprises a conveyor disposed proximate the winch and the winch comprises a spooling arm movable between (i) a position above the conveyor wherein a proximate one of the plurality of weights is disposed and (ii) a position above the subsurface well.

In some embodiments, the conveyor comprises a belt conveyor.

In some embodiments, the conveyor comprises a rotary table conveyor.

In some embodiments, the means for selectively connecting comprises a releasable latch.

In some embodiments, the means for selectably releasing comprises a weight latch disposed proximate a top of the subsurface well and a cable latch disposed at an end of the cable, wherein a first one of the plurality of weights is latchable in the weight latch, the first one of the plurality of weights comprising a through bore, and wherein the cable latch is operable to connect to a latch feature on an upper end of a second one of the plurality of weights disposed below the first one of the plurality of weights.

Other aspects and possible advantages will be apparent from the description and claims that follow.

### BRIEF DESCRIPTION OF THE DRAWINGS

FIG. 1 shows an example embodiment of a conveyor system to load and unload multiple weights onto a winch cable for lowering into a well to release energy and retrieving them from the well to store energy.

FIG. 2 shows another example embodiment of a conveyor system.

FIGS. 3A through 3H show an example embodiment of lowering multiple weights individually within a well and raising the weights individually so as to maintain power production or energy storage for an extended time.

FIG. 4 shows a multiple well arrangement in which a system according to the present disclosure is disposed on each of a plurality of wells.

### DETAILED DESCRIPTION

Apparatus and methods according to the present disclosure comprise selectively disposing weights (masses) on a cable. The cable is coupled to a motor/generator winch such that movement of the weight(s) downward by gravity drives the generator to produce electrical power; conversely when electrical power is to be stored, the motor/generator winch operates to retract the cable and lift the weight(s).

In various embodiments of an apparatus according to the present disclosure, the one or more weights attached to the cable may be lowered into and retrieved from a subsurface well. In some embodiments, the well may be a preexisting well drilled for other purposes such as extraction of oil and gas from the subsurface, wherein after the well has reached the end of its economically useful life, may be reused for energy storage using various embodiments of an apparatus as disclosed herein.

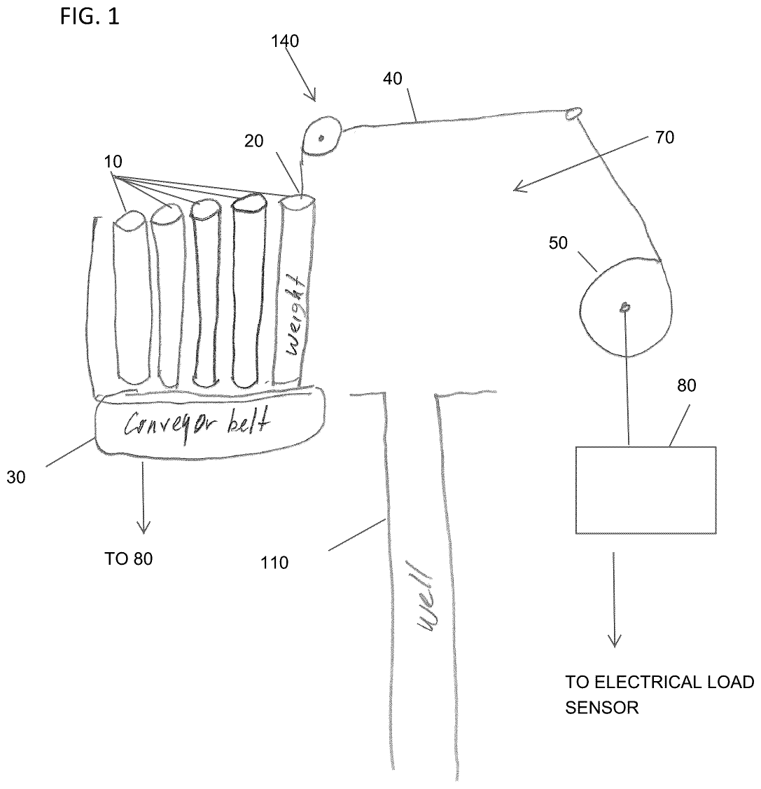

FIG. 1 shows schematically an example embodiment of a weight storage and deployment apparatus 70. The weight storage and deployment apparatus 70 may comprise a plurality of weights 10. The weights 10 may be in the form of elongated cylinders capable of moving freely along the interior of a subsurface well 110. The subsurface well 110 as explained above may be, for example and without limitation, a repurposed oil and gas extraction well. A motor/generator winch 50 may have wound thereon a cable 40. The motor/generator winch 50 may be rotated by gravity-induced motion of the cable 40 to generate electrical power (acting as a generator) and may rotate to move the cable 40, e.g., retract it an lift weight(s) by consuming electrical power. The cable 40 may be directed by a spooling arm 140 to dispose a latch 20 connected to a free end of the cable 40 to a position over one of the plurality of weights 10 such that the latch 20 may make connection to the one of the plurality of weights 10. In this way, the latched-onto weight 10 may be lifted by the cable 20, and moved laterally, using the spooling arm 140, to a position above the well 110.

The plurality of weights 10 may be stored, for example, on a belt type conveyor 30, wherein removal of one of the weights 10 to be dropped into the well 110 may be followed by movement of the belt type conveyor 30 to move a subsequent one of the weights 10 into position for latching by the latch 20.

Operation of the motor/generator winch 50 may be governed by a controller 80 such as a microprocessor, programmable logic controlled, field programmable gate array or any similar device. Analog circuitry and/or devices to perform functions as described herein may also serve the stated functions of the controller; implementation using digital circuitry is not a limitation on the scope of this disclosure. The controller 80 may be in signal communication with an electrical load and generator output sensor (not shown) which may generate a signal corresponding to a difference between output of an intermittent generator (not shown) and an electrical load (not shown).

When the electrical load on the intermittent electrical generator (not shown) is greater than the output of such generator (called excess load condition for convenience), the controller 80 may cause the motor/generator winch 50 to be operated to allow the latched onto weight 10 to drop into the well 110, wherein extension of the cable 40 causes rotation of the motor/generator, thus generating electrical power. In the event the excess load condition continues beyond the drop of the latched weight 10 to the bottom of the well 110, the latch 20 may be released, the winch motor/generator 50 may be operated to retract the cable 40 from the well 110 with the weight thus detached, and the spooling arm 140 operated to dispose the latch 20 above a subsequent weight 10. The subsequent weight 10 may then be disposed at the top of the well 110 and the weight drop repeated until the earlier of either the excess load condition ends or the subsequent weight 10 reaches the bottom of the well 110.

If the excess load condition is maintained, the foregoing process of unlatching the weight 110 from the cable 40, lifting and positioning subsequent ones of the weights 10 and allowing such weight(s) to drop in the well 110 may continue until all the weights 10 stored on the conveyor 30 are disposed in the well 110.

When the load applied to the intermittent electrical generator (not shown) is less than the generator output (referred to as an excess power condition), the process explained above may be reversed by the controller 80 causing the motor/generator winch 50 to operate in motor mode, so as to lift the weights 10 from the well 110 and to dispose them on the belt type conveyor 30. Such process of lifting and storing the weights onto the belt type conveyor 30 may continue for the duration of the excess power condition. If the excess power condition ceases during the above described weight lifting procedure such that an excess load condition begins, the controller 80 may cause the process to reverse automatically such that the weight(s) are once again dropped into the well 110 as previously explained.

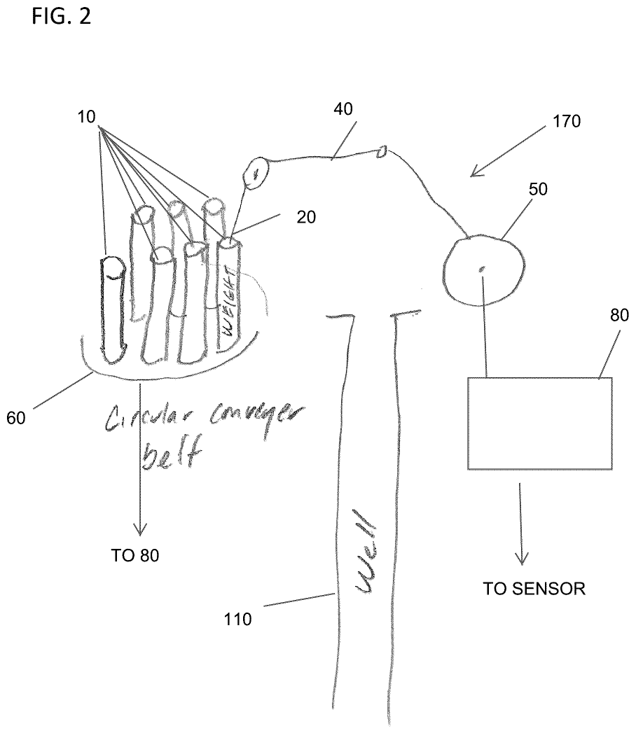

FIG. 2 shows another example embodiment of an energy storage system 170. The system shown in FIG. 2 may include all the components described with reference to FIG. 1, and wherein a conveyor 60 may be a rotary table type conveyor. Operation of the system 170 shown in FIG. 2 may be substantially identical to operation of the system explained with reference to FIG. 1, other than the details of operation of the conveyor 60.

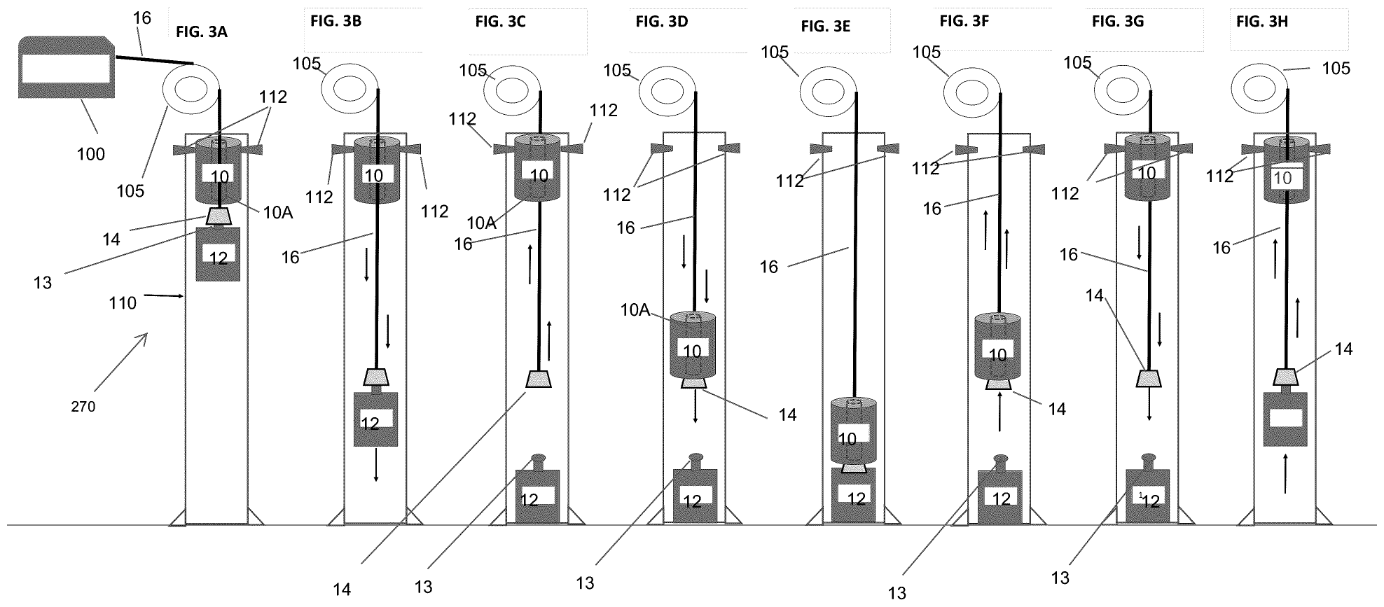

FIGS. 3A through 3H show schematically a structure of and method for operation of another example embodiment of a weight drop energy storage system (shown generally at 270 in FIG. 3A) according to the present disclosure. In FIG. 3A, a first weight 10 may be suspended proximate the top of a well 110 by a latch 112 (hereinafter “weight latch”). The first weight 10 may comprise a through bore 11 such that a cable 16 spooled on a motor/generator winch 100 (hereinafter “winch” for convenience) may selectively pass through the first weight 10. The winch 100 may operate in a similar manner as in other embodiments explained herein. The cable 16 may comprise a cable latch 14 on its free end that can releasably connect to a latching feature 13 on an upper end of a second weight 12. In some embodiments, the cable latch 14 may comprise an “overshot” and shoulder hoist of types known in the art. In some embodiments, the latching feature 13 may comprise a “fishing neck” of types known in the art that can cooperatively engage the overshot when such is used for the cable latch 14. In some embodiments, one or more sheaves 105 may guide the cable 16 into the well 110 from the winch 100.

The system in FIGS. 3A through 3H may comprise a controller similar in form and function to the controller described with reference to FIGS. 1 and 2. In FIG. 3B, when the controller (80 in FIG. 1) detects an excess load condition, the controller (80 in FIG. 1) may operate the winch (100 in FIG. 3A) as a generator, and allow the second weight 12 to drop into the well 110. If the excess load condition continues beyond the point at which the second weight 12 reaches the bottom of the well 110, and referring to FIG. 3C, the controller (80 in FIG. 1) may cause the cable latch 14 at the end of the cable 16 to release, and the cable 16 may be retracted until the cable latch 14 makes contact with the bottom of the first weight 10, as shown in FIG. 3D.

In FIG. 3D, the controller (80 in FIG. 1) may then release the weight latch 112, operate the winch (100 in FIG. 3A) as a generator so that the first weight 10 is lowered into the well 110 and thereby generates power to at least partially satisfy the excess load condition. The first weight 10 may continue to drop until it reaches the top of the first weight 12 at the bottom of the well 110 as shown in FIG. 3E.

In FIG. 3F, when an excess power condition begins, the controller (80 in FIG. 1) may cause the winch (100 in FIG. 3A) to lift the first weight 10 until it reaches the weight latch 112. Once the first weight 10 reaches the weight latch 112 as shown in FIG. 3G, the weight latch 112 may be operated to hold the first weight 10 in place and the winch (100 in FIG. 3A) may then be operated to extend the cable 16 until the cable latch 14 reaches the latching feature 13 at the top of the second weight 12.

In FIG. 3H, if the excess power condition continues, the cable latch 14 may connect to the feature 13 and the winch (100 in FIG. 3A) may be operated to lift the second weight 12. Such lifting may continue depending on the power condition until the second weight 12 reaches the first weight 10, i.e., the condition shown in FIG. 3A.

The embodiment described with reference to FIGS. 3A through 3H may comprise two weights and one weight latch as shown. It will be apparent to those skilled in the art that other embodiments may have more than two weights with associated weight latches and accompanying latching features to enable longer periods of power generation by the apparatus or energy storage by the apparatus be sequentially lowering and lifting weights in a well, respectively.

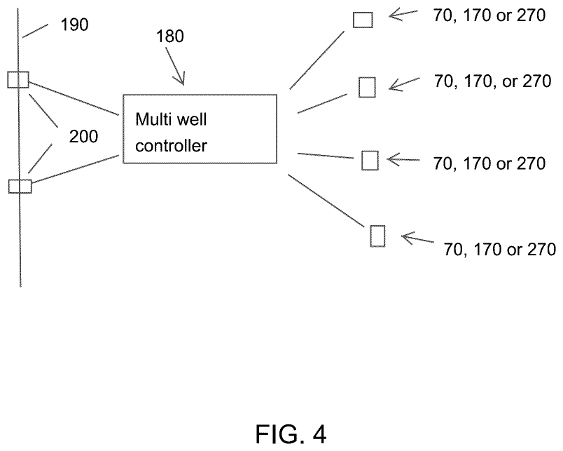

Further and with reference to FIG. 4, the various embodiments of an apparatus as described herein (e.g., 70 in FIG. 1, 170 in FIG. 2 and 270 in FIG. 3A) may be deployed on each of a plurality of wells, wherein a multi well controller 180 may include one or more sensors, e.g., current sensors 200 disposed about a power transmission line 190 to detect the magnitude of excess load condition or excess power condition, and operate a number of storage systems 70. 170, 270 as disclosed herein in proportion to such magnitude. In embodiments such as shown in FIG. 4, the multi well controller 180 may perform the function of the individual controller (80 in FIG. 1) otherwise provided for individual well systems, that is, an individual controller need not be provided at the energy storage system associated with each well.

A system and method as described herein may make more efficient use of existing wells in that the same well depth may be used for multiple periods of time to generate power by dropping weights sequentially and to store energy by lifting weights sequentially. Thus, a particular well may have its effective weight lift/drop length multiplied by the number of weights stored proximate to and deployed in such well. The foregoing may substantially reduce the cost of gravity-type energy storage for use with intermittent electric power generators.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. Apparatus for storing energy, comprising:
a subsurface well;
a cable cooperatively engaged with a winch, the winch comprising a motor/generator wherein electrical power applied to the motor/generator operates the winch to retract the cable, and wherein motion applied to the cable operates the winch to generate electrical power;
a plurality of weights disposed proximate the subsurface well, the plurality of weights shaped to enable movement along an interior of the subsurface well; and
means for selectively connecting each of the weights to the cable, wherein each of the plurality of weights is individually connectable to the cable to either induce motion on the cable by gravity by releasing the weights into the subsurface well or be withdrawn from the well by the cable.

2. The apparatus of claim 1 wherein the means for selectively connecting comprises a conveyor disposed proximate the winch and the winch comprises a spooling arm movable between (i) a position above the conveyor wherein a proximate one of the plurality of weights is disposed and (ii) a position above the subsurface well.

3. The apparatus of claim 2 wherein the conveyor comprises a belt conveyor.

4. The apparatus of claim 2 wherein the conveyor comprises a rotary table conveyor.

5. The apparatus of claim 1 wherein the means for selectively connecting comprises a releasable latch.

6. The apparatus of claim 1 further comprising a controller in communication with the winch and with a sensor, the sensor operable to detect an excess load condition wherein a load applied to an intermittent electrical generator exceeds a power output of the intermittent electrical generator, the sensor operable to detect an excess power condition wherein the power output exceeds the load, and wherein the controller is operable to (i) cause the winch to operate to release one of the weights into the subsurface well during the excess load condition and (ii) to cause the winch to withdraw one of the plurality of weights from the subsurface well during the excess power condition.

7. The apparatus of claim 1 wherein the means for selectably releasing comprises a weight latch disposed proximate a top of the subsurface well and a cable latch disposed at an end of the cable, wherein a first one of the plurality of weights is latchable in the weight latch, the first one of the plurality of weights comprising a through bore, and wherein the cable latch is operable to connect to a latch feature on an upper end of a second one of the plurality of weights disposed below the first one of the plurality of weights.

8. A method for releasing stored energy, comprising:
disposing a first weight in a weight latch proximate a top of a well;
passing a cable having a cable latch at one end through a bore in the first weight;
attaching the cable latch to a top end of a second weight disposed in the well below the first weight;
detecting a load on an intermittent electric generator;
when the load exceeds a power output of the generator, operating a motor/generator winch in contact with the cable to release the second weight into the well;
when the second weight reaches the bottom of the well, retracting the cable until it contacts a bottom of the first weight;
releasing the weight latch and allowing the first weight to move toward the bottom of the well.

9. A method for storing energy, comprising:
detecting a load on an intermittent electric generator;
when the load is less than a power output of the generator, operating a winch to lift a first weight stacked above a second weight at a bottom of a well, until the first weight is disposed in a weight latch proximate the top of the well;
operating the weigh latch to retain the first weight;
extending the cable into the well until a cable latch on an end of the cable contacts and engages a latching feature on a top of the second weight;
lifting the second weight from the bottom of the well by operating the winch to withdraw the cable from the well.

10. An apparatus for storing energy, comprising:
a plurality of subsurface wells, wherein is disposed proximate to each of the plurality of wells;
a cable cooperatively engaged with a winch, the winch having a motor/generator wherein electrical power applied to the motor/generator operates the winch to retract the cable, and wherein motion applied to the cable operates the winch to generate electrical power,
a plurality of weights disposed proximate the subsurface well, the plurality of weights shaped to enable movement along an interior of the subsurface well and
means for selectively connecting each of the weights to the cable, wherein each of the plurality of weights is individually connectable to the cable to either induce motion on the cable by gravity by releasing the weights into the subsurface well or be lifted within the well by the cable;
a sensor arranged to detect existence of and magnitude of an excess load condition or an excess power condition on a power line; and
a multi well controller in signal communication with the sensor and in communication with the motor/generator on each winch., the multiple well controller operable to cause a number of the motor/generators to operate, respectively, as a motor or a generator in proportion to the magnitude of the excess load condition or the excess power condition.

11. The apparatus of claim 10 wherein the means for selectively connecting comprises a conveyor disposed proximate the winch and the winch comprises a spooling arm movable between (i) a position above the conveyor wherein a proximate one of the plurality of weights is disposed and (ii) a position above the subsurface well.

12. The apparatus of claim 11 wherein the conveyor comprises a belt conveyor.

13. The apparatus of claim 11 wherein the conveyor comprises a rotary table conveyor.

14. The apparatus of claim 10 wherein the means for selectively connecting comprises a releasable latch.

15. The apparatus of claim 10 wherein the means for selectably releasing comprises a weight latch disposed proximate a top of the subsurface well and a cable latch disposed at an end of the cable, wherein a first one of the plurality of weights is latchable in the weight latch, the first one of the plurality of weights comprising a through bore, and wherein the cable latch is operable to connect to a latch feature on an upper end of a second one of the plurality of weights disposed below the first one of the plurality of weights.
